(19) United States
(12) Patent Application Publication
(10) Pub. No.: US 2021/0383341 A1
(43) Pub. Date: Dec. 9, 2021

(54) SELF-CHECKOUT METHOD AND APPARATUS FOR UNPACKAGED PRODUCTS

(71) Applicants: Jun Wang, Xi'an (CN); Weijun Zhang, San Francisco, CA (US)

(72) Inventors: Jun Wang, Xi'an (CN); Weijun Zhang, San Francisco, CA (US)

(21) Appl. No.: 17/151,686

(22) Filed: Jan. 19, 2021

Related U.S. Application Data
(60) Provisional application No. 62/937,119, filed on Nov. 18, 2019.

(51) Int. Cl. G06Q 20/18; G06Q 20/20; G06Q 20/32

(52) U.S. Cl. CPC G06Q 20/18; G06Q 20/3276; G06Q 20/208

(57) ABSTRACT

A method and a vending apparatus for self-checkout unpackaged products is disclosed. The vending apparatus holds goods on one or more product trays. Load cells are mounted under each product tray and can measure the weight of the goods on the product tray in real time. A user may use a credit/debit card or an online payment app to unlock the vending apparatus and to initiate a purchase. The user may take any desired amount of goods. The apparatus automatically detects the type of goods and the weight amount taken by the user and calculates the total cost. After the user payment, the apparatus automatically resets the initial weight of the goods and is ready for the next transaction. The present invention improves the vending machine technology and expands its application to offering unpackaged products.

### CROSS-REFERENCE TO RELATED APPLICATIONS

This application claims priority to Provisional U.S. Patent Applications No. 62/937,099, No. 62/937,119, and No. 62/937,124, filed Nov. 18, 2019, the entirety of which are incorporated by reference herein.

### BACKGROUND OF THE INVENTION

### Field of Invention

The invention generally relates to the field of vending machines and self-checkout methods.

### Background Art

With the development of the Internet economy, self-checkout has become an increasingly popular choice to the public due to its convenience. The current vending machines are designed for selling packaged products only. For example, using a vending machine, a customer will get a bottle of beverage or a bag of chips by paying the respective marked price. However, there are many products that are sold without packaging, like fruits, vegetables, and many types of cooked foods. The cost of unpackaged goods typically is not determined by units but rather indirectly by weight. It is usually calculated as the product of its weight and its unit price. Another example would be getting a meal from a salad bar, or food bar, where the total cost of the meal may also be calculated according to the weight of the meal. There is a need for a convenient and automatic means to offer unpackaged goods for sale and the user can purchase any desired amount of the unpackaged goods.

### SUMMARY OF THE INVENTION

The present invention fulfills the need to provide self-checkout for unpackaged products. Unpackaged products may include food items, beads, semi-precious stones, small parts, or craft materials, etc. The present invention is particularly suitable for offering unpackaged foods. In accordance with one preferred embodiment of the present invention, a self-checkout apparatus offers unpackaged food, such as fruits, vegetables, grains, salad, meals, ice cream, soup, beverage, other cooked or prepared food. More specifically, it uses a weighing-by-difference method to automatically show the amount of unpackaged food has been taken by a customer in real time and calculate the cost for self-checkout.

A self-checkout apparatus in accordance with one embodiment of the present invention works like an improved vending machine for unpackaged goods. A customer can freely choose any amount of unpackaged goods. The self-checkout apparatus uses a weighing-by-difference method to automatically display the cost of unpackaged goods taken by a customer, allowing the customer to pay by a credit/debit card, using WeChat to read a QR code, or using other online payment methods like Alipay, etc. The present invention has great flexibility in its application and can be applied to self-checkout for food products and non-food products.

In a further embodiment of the present invention, the control panel of the self-checkout vending apparatus has a code scan area. The code scan area has a QR code or a QR code reader, which supports payments via WeChat and Alipay. When the central processing unit receives a signal based on a customer scan activity, the central processing unit unlocks a door or controls an actuator to open a product access window so that the customer can get the desired goods. When the central processing unit receives a completion signal or successful completion of payment, the central processing unit locks the door or controls an actuator to close the product access window.

In a further embodiment of the present invention, the self-checkout vending apparatus is connected to an external operating and accounting platform that includes an accounting module and an operation identification module. The self-checkout vending apparatus comprises a code scan area which has a QR code or QR code reader. When sensing a scanning activity, the operation identification module sends a request for access to goods to the central processing unit via a signal transceiver. When finished, the central processing unit generates and sends payment details to the accounting module, which then settles the payment accordingly.

The self-checkout vending apparatus comprising a product tray, integrated load cells, a central processing unit, and a means to control the access to goods offered. In one preferred embodiment, a card reader's successful reading of a customer's card opens the access to the goods offered. In an alternative preferred embodiment, a customer may use a mobile device to scan a code on the self-checkout vending apparatus to gain the access to the good offered.

The integrated load cells measure the weight of the goods on the product tray and sends the updated weight measurement to the central processing unit in real time. As a customer getting an amount of goods, the weight of the goods taken is calculated by the central processing unit as the difference of the weights of the goods on the product tray before and after the customer getting the amount of goods. The central processing unit calculate a cost of the goods taken based on the weight of the goods taken and the unit price of the goods. After the customer pays for the goods taken, the access to the goods offered is closed.

The central processing unit of the self-checkout vending apparatus controls a data storage that maintains the initial weight of goods on each product tray and their unit price information. The unit price information is entered into the data storage system when the goods are replenished. The initial weight is updated using the most recent weight of the remaining goods after each time a purchase is made.

A self-checkout vending apparatus in accordance with the present invention holds goods on one or more product trays. The product trays may hold different types of goods with different unit prices. Load cells are mounted under each product tray and can measure the weight of the goods on each product tray in real time. A user may use a card or an online payment app to unlock/open the vending apparatus and to initiate a purchase. The central processing unit checks if the vending apparatus is out of stock based on the current weight of goods on the one product tray or the current total weight on all the product trays. If out-of-stock, an alert is triggered and transmitted by the central processing unit. The user may take any desired amount of goods from any tray. The apparatus automatically detects the type of goods and the weight amount taken by the user and calculates the total cost. After the user payment, the apparatus automatically resets the initial weight of the goods on each product tray and gets ready for the next purchase.

The present invention provides the following unique solutions and features:

1) The present invention enables automatic checkout of unpackaged products without assistance from store attendants. The invention has broad applications and can be applied to self-checkout of any unpackaged products.

2) The present invention comprises a self-checkout vending apparatus that incorporates a weighing-by-difference method, wherein the cost is calculated based on a unit price of goods offered and a weight of a desired amount of goods taken by a customer. And the weight of the goods taken by the customer is the weight difference of the goods on a scale that is integrated in the apparatus before and after the customer taking the desired amount of goods. This solves the problem of prior vending apparatuses being unable to sell unpackaged goods. The present invention improves the vending machine technology and broadens the application of vending machines.

3) The invention further comprises a cloud-based server and a customer device (for example, a smart phone) that interact with a self-checkout vending apparatus during a vending operation. The self-checkout vending apparatus has a code scan area to be used with the customer device. The self-checkout vending apparatus automatically open a product access area for the customer to access the product offered when a scanning activity by the customer is confirmed. After the customer finishes getting the desired amount of product, the self-checkout vending apparatus automatically completes the payment transaction based on a code scan payment method, password-less authentication, or auto-debit service empowered by online payment platforms like WeChat or Alipay.

4) The present invention has broad applications as it enables unmanned automated retail for any packaged or unpackaged products.

### BRIEF DESCRIPTION OF THE DRAWINGS

The accompanying drawings, which are incorporated in and constitute a part of the specification, illustrate embodiments of the invention and together with the description, further serve to explain the purpose, advantages, and principles of the invention and to enable a person skilled in the art to make and use the invention.

FIG. 1 illustrates the schematic view of a self-checkout vending apparatus in accordance with a first embodiment of the present invention.

FIG. 2 illustrates the schematic view of the self-checkout vending apparatus in accordance with the first embodiment of the present invention and with a protective shield removed.

FIG. 3 illustrates the schematic view of a self-checkout vending apparatus in accordance with a second embodiment of the present invention.

FIG. 4 illustrates the front view of the self-checkout vending apparatus in accordance with the second embodiment of the present invention.

FIG. 5 illustrates the end view of the self-checkout vending apparatus in accordance with the second embodiment of the present invention.

FIG. 6 illustrates the top view of the self-checkout vending apparatus in accordance with the second embodiment of the present invention.

FIG. 7 depicts a block diagram of a self-checkout vending system including major functional blocks of a self-checkout vending apparatus in accordance with the first embodiment and the second embodiment of the present invention.

FIG. 8 illustrates the schematic view of a self-checkout vending apparatus in accordance with a third embodiment of the present invention.

FIG. 9 depicts a block diagram of a self-checkout vending system including major functional blocks of a self-checkout vending apparatus in accordance with the third embodiment of the present invention.

### DETAILED DESCRIPTION OF INVENTION

### A. Introduction

The following description presents various embodiments of the present invention. They are presented by way of examples, and not limitations.

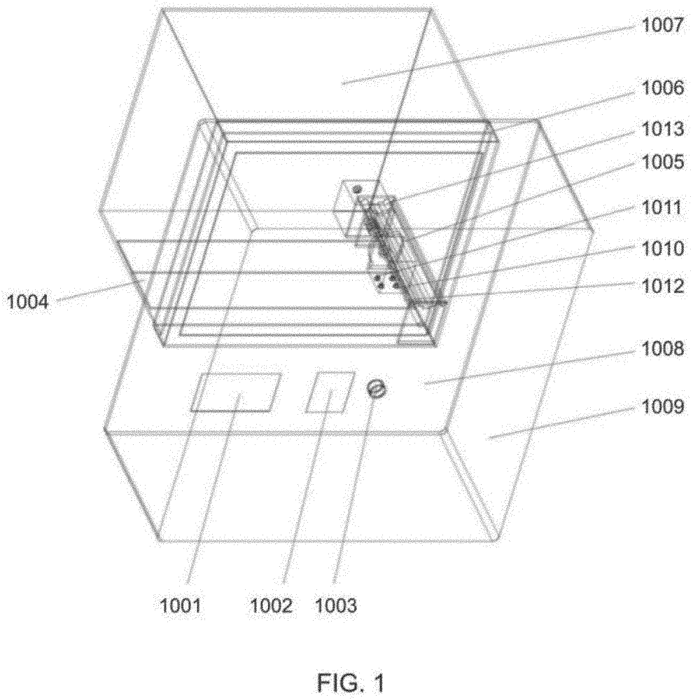

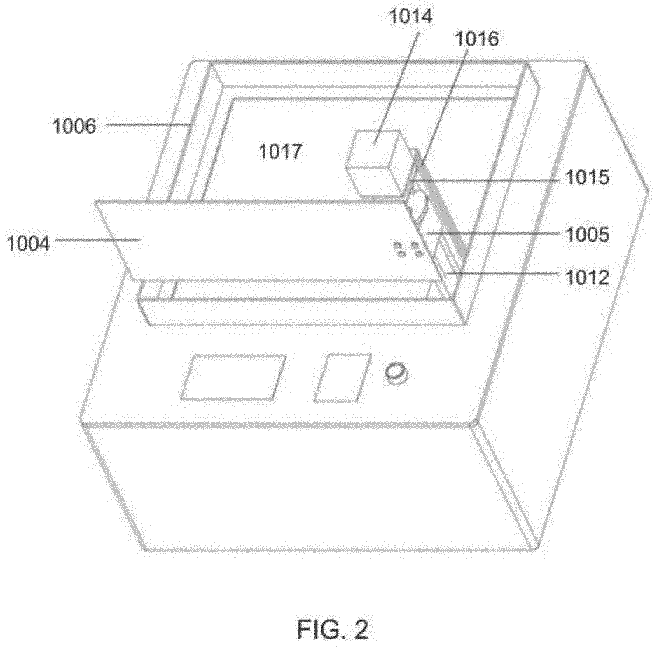

FIGS. 1 and 2 illustrate schematic views of a self-checkout vending apparatus in accordance with a first embodiment of the present invention, which features a sliding door. The self-checkout vending apparatus automatically calculates the value of the unpackaged products based on a weighing by difference method. The numbered labels in the FIGS. 1-2 indicate different parts of the apparatus: 1001—Display; 1002—Code scan area; 1003—End button; 1004—Sliding door; 1005—Slider; 1006—Fitting component; 1007—Protective shield; 1008—Control panel; 1009—Base unit; 1010—Nut; 1011—Nut mount; 1012—Screw rod; 1013—Linear guide; 1014—Electric motor; 1015—Fitting for electric motor, 1016—Holder; 1017—Product tray.

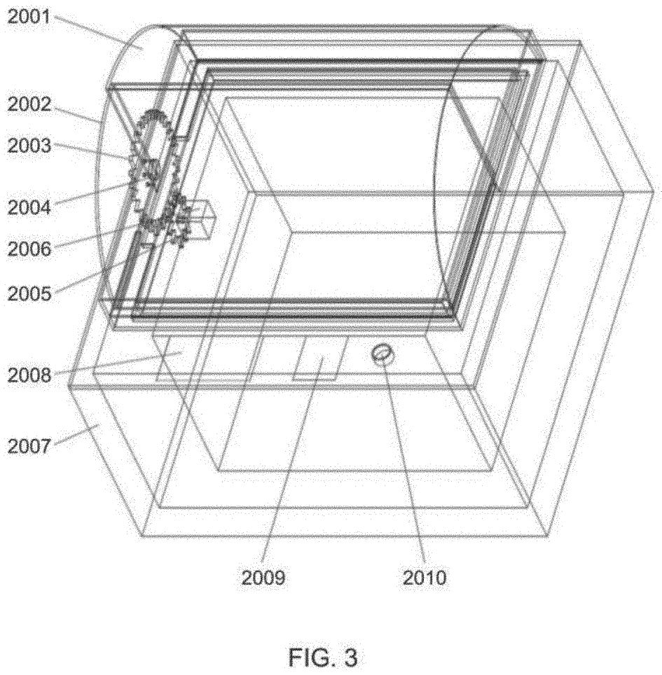

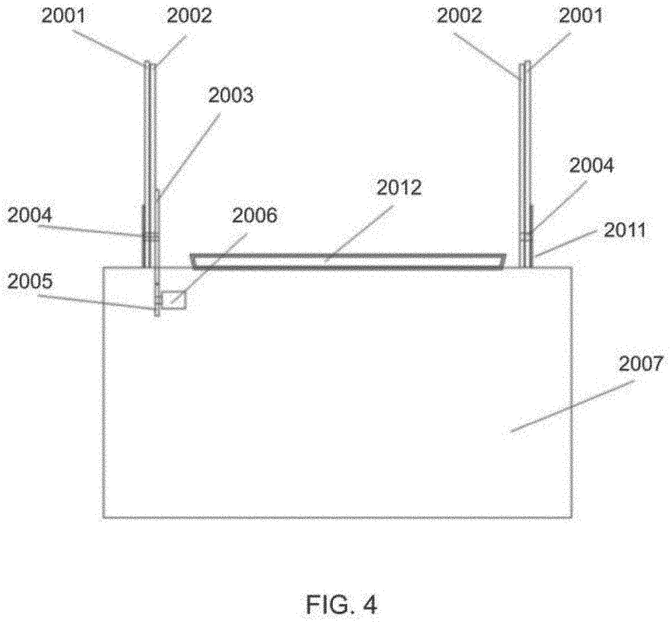

FIGS. 3-6 illustrate schematic views of a self-checkout vending apparatus in accordance with a second embodiment of the present invention, which features a roll top cover. The self-checkout vending apparatus automatically calculates the value of the unpackaged products based on a weighing by difference method. The numbered labels in the FIGS. 3-6 indicate different parts of the apparatus: 2001—Fixed cover; 2002—Roll top cover; 2003—Transmission gear; 2004—Bearing; 2005—Motor gear; 2006—Electric motor; 2007—Base unit; 2008—Display; 2009—Code scan area; 2010—Reset button; 2011—Fitting component; 2012—Product tray; 2013—Control Panel.

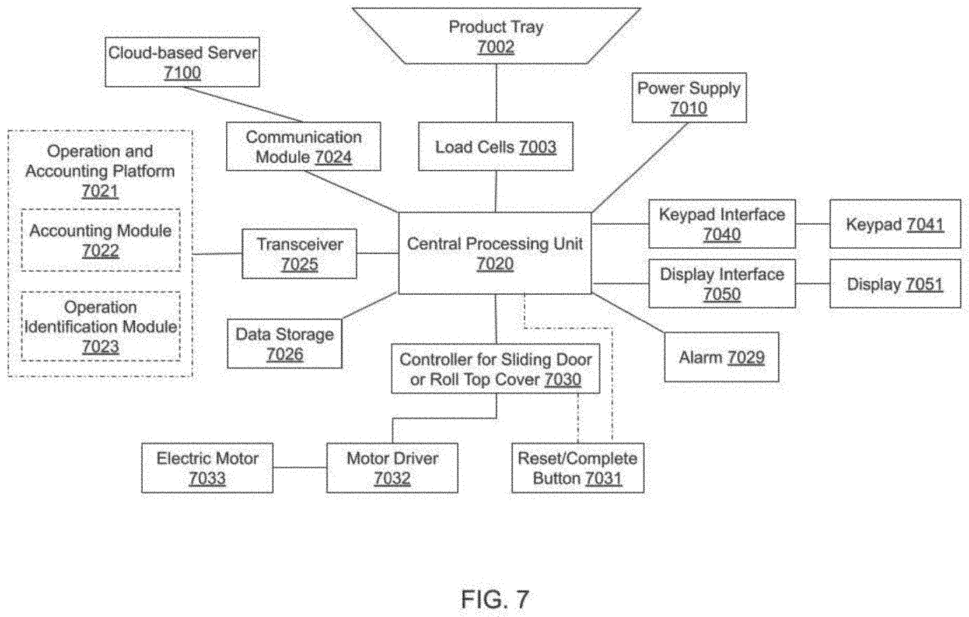

Other than the door/cover moving mechanism, the first embodiment and the second embodiment of self-checkout vending apparatuses share a similar functional structure. As illustrated in the block diagram FIG. 7, the first/second self-checkout vending apparatus for unpackaged products comprises a central processing unit 7020, a product tray 7002, load cells 7003, a power supply 7010, a keypad interface 7040, a keypad 7041, a display interface 7050, a display 7051, a controller 7030 for sliding door or roll top cover, a motor driver 7032, an electric motor 7033, data storage 7026, transceiver 7025, and communication module 7024. The product tray 7002 is corresponding to the product tray 1017 in FIGS. 1-2 for the first embodiment, or the product tray 2012 in FIGS. 3-6 for the second embodiment. In a further preferred embodiment, the vending apparatus works with a cloud-based server 7100, which may control the vending apparatus off-site.

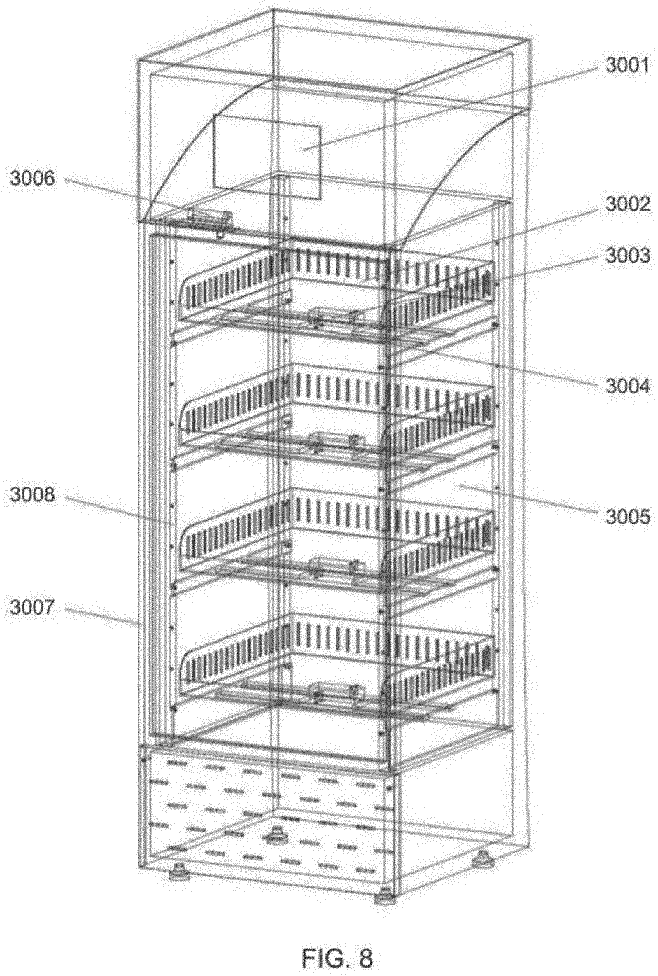

FIG. 8 illustrates a schematic view of a self-checkout vending apparatus in accordance with a third embodiment of the present invention, which features a cabinet that displays products on a plurality of product trays. The numbered labels in the FIG. 8 indicate different parts of the apparatus: 3001—Display unit; 3002—Product tray; 3003—Load cells; 3004—Shelf; 3005—Cabinet; 3006 —Electromagnetic lock; 3007—Cabinet door; 3008—Rack.

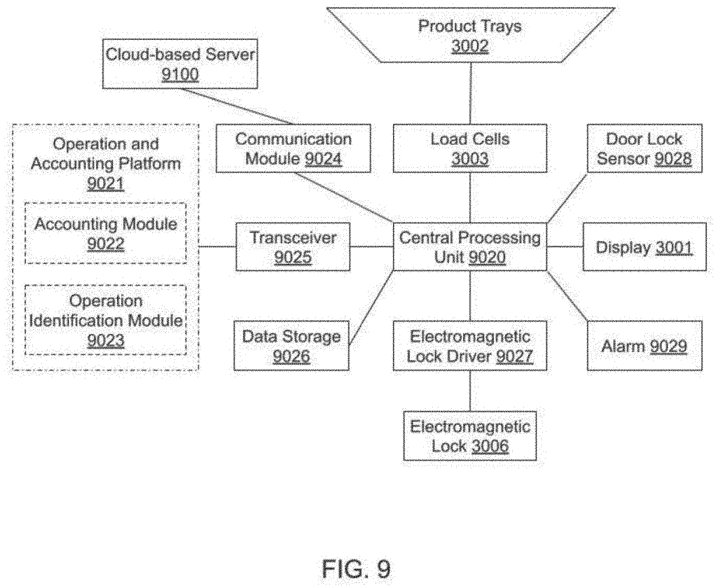

FIG. 9 illustrates a block diagram of a self-checkout vending system including major functional blocks of the self-checkout vending apparatus in accordance with the third embodiment of the present invention. As illustrated, the system of FIG. 9 is similar to the system of FIG. 7 other than the product access control mechanisms and their relevant functions: Electromagnetic Lock 3006, Electromagnetic Lock Driver 9027, and Door Lock Senor 9028 in FIG. 9 vs. Controller for Sliding Door or Roll Top Cover 7030, Motor Driver 7032, Motor 7033, and Reset/Complete Button 7031 in FIG. 7.

### B. Detailed Description of the First Embodiment

As illustrated in FIGS. 1, 2, and 7, a first embodiment of self-checkout vending apparatus is based on a weighing by difference method for selling unpackaged products. The apparatus comprises a display 1001, a keypad 7041, an alarm 7029, an end button 1003, a sliding door 1004, a slider 1005, a fitting component 1006, a protective shield 1007, a control panel 1008, a base unit 1009, a nut 1010, a nut mount 1011, a screw rod 1012, a linear guide 1013, an electric motor 1014, a fitting for the electric motor 1015, a holder 1016, a product tray 1017, and a controller unit. As illustrated in FIG. 7, the controller unit further comprises load cells 7003, a central processing unit 7020, a power supply 7010, a keypad interface 7040, a display interface 7050, a sliding door controller 7030 (optional), a motor driver 7032, a data storage 7026, a transceiver 7025, and a communication module 7024. The present invention may further comprise a cloud-based server 7100 that controls the self-checkout vending apparatus remotely.

As illustrated in FIGS. 1, 2, and 7, the control panel 1008 is on top of the base unit 1009. In a preferred embodiment, the control panel 1008 is made of glass. The base unit 1009 has a rectangular opening on the top, where the product tray 1017 is placed. The product tray 1017 is used for holding a given amount of goods, which is a type of product, especially unpackaged product, that is offered for sale. A weight sensor such as one or more load cells 7003 is under the product tray 1017. The load cells 7003 is connected to a central processing unit 7020. The load cells 7003 measures the current weight of the remaining goods on the product tray 1017 and updates the central processor 7020 about the weight in real time. When the central processor 7020 receives a completion signal, the central processor 7020 calculates an amount of goods taken by a customer (i.e., weight of goods sold) based on the difference between an initial weight from the load cells 7003 and the current remaining goods weight from the load cells 7003. The completion signal indicates that the customer has finished taking the goods on the product tray 1017. Next, the central processor 7020 calculates a cost of goods taken by the customer (i.e., payment amount) based on the weight of goods sold and a unit price of goods (i.e., the unit price for the type of product for sale). The unit price is stored in a data storage 7026.

The product tray 1017 is surrounded by a fitting component 1006. The fitting component is securely mounted on the base unit 1009 and forms a rectangular surrounding structure outside of the product tray 1017. The protective shield 1007 can be then fastened onto the base unit 1009 by attaching it to the inner surface or the outer surface of the fitting component 1006. The means of fastening may be using glue, recessed grooves, or screws, etc. The protective shield 1007 protects the goods offered for sale on the product tray 1017. Preferably the protective shield 1007 is transparent so that the customers can clearly view the product inside. On at least one side of the protective shield 1007, there is an opening through which the goods can be placed and taken. The sliding door 1004 conforms to the shape of the opening. The preferred shape of the opening is rectangular. The sliding door can be moved to facilitate the placing and fetching the goods inside. The opening of the protective shield 1007 serves as the product access window.

An actuator for the sliding door is mounted in a corner of the protective shield close to the product access window. The actuator is fastened onto the inner surface of the fitting component 1006. The actuator comprises a slider 1005, a nut 1010, a nut mount 1011, a screw rod 1012, a linear guide 1013, an electric motor 1014 for moving the sliding door, a fitting for the electric motor 1015, and a holder 1016. The holder 1016 is fastened to an inner surface of the base unit 1006 near the product access window. The fitting for the electric motor 1015 is fastened to the top of the holder 1016. The electric motor 1014 is mounted on the ceiling of the fitting for the electric motor 1015. The screw rod 1012 is installed under the fitting for the electric motor 1015. The screw rod 1012 extends vertically along the linear guide 1013. The rotation of the screw rod 1012 is driven by its top attached to the output shaft of the electric motor 1014. The slider 1005 is connected to the screw rod 1012 and can move up and down along it. One side of the sliding door 1004 is fastened to the slider 1005. More specifically, the slider 1005 is mounted to the sliding door 1004 through the nut 1010 and the nut mount 1011. In this way, the electric motor 1014 drives the screw rod to rotate, which moves the slider 1005 up and down, and in turn moves the sliding door 1004 up and down. Hence the sliding door 1004 can control the opening and close of the product access window. When the sliding door 1004 is driven by the slider 1005 to move upwards, the product access window is opened. When the sliding door 1004 is driven by the slider to move downwards, the window is then closed.

The control panel 1008 further comprises a display 1001, a code scan area 1002, and an end button 1003, which are preferably in the front of the sliding door. The display 1001 (i.e., 7051 in FIG. 7) is connected to the central processing unit 7020 via the display interface 7050. The central processing unit 7020 displays customer's purchasing and payment information on the display 1001 in real time. The code scan area 1002 has a scannable code, which is preferably a 2D barcode or QR code that supports WeChat payment and Alipay. The end button 1003 is connected to either the central processing unit 7020 or a sliding door controller 7030.

In a further preferred embodiment, the sliding door 1004 may be made of glass or acrylic glass. The protective shield is fixed glass shield. The control panel is also made of glass. The screw rod is preferred to be a ball screw rod. The electric motor is preferred to be a stepper motor, which transforms the rotation to linear movement via the ball screw rod.

A controller unit is installed inside the base unit 1009. The controller unit comprises load cells 7003, a central processing unit 7020, a power supply 7010, a keypad interface 7040, a display interface 7050, a motor driver 7032, a data storage 7026, a transceiver 7025, and a communication module 7024. The central processing unit 7020 is preferably an ARM 32-bit central processor. The central processing unit 7020 is connected to the load cells 7003, the power supply 7010, the keypad interface 7040, the display interface 7050, the alarm 7029, the data storage 7026, the transceiver 7025, and the commination module 7024.

The load cells 7003 detect a current weight of product on the product tray 1017 and sends a measurement to the central processing unit 7020 in real time. Hence the central processing unit 7020 has an initial weight of the goods on the product tray 1017 before a customer starts taking some of the goods from the vending apparatus. After the customer finishes taking the desired amount of the goods from the vending apparatus, the central processing unit 7020 receives a completion signal and then automatically calculates and displays a cost of the goods taken by the customer based on the following: a most updated weight of the remaining goods on the product tray 1017, a weight difference between the initial weight stored in the data storage and the updated weight, and the unit price of the goods stored in the data storage. The central processing unit 7020 generates an amount due based on the cost of goods taken by the customer. Finally, the central processing unit 7020 shows the amount due on the display 1001 to the customer and sends the amount due to an operation and accounting platform 7021 to close the transaction.

The data storage 7026 connected to the central processing unit 7020 stores the unit price of the goods offered for sale and the initial weights of the goods prior to each transaction. The unit price is received during an initialization when the vending apparatus is replenished with the goods for sale. The central processing unit 7020 controls the data storage 7026 that maintains the initial weight. The central processing unit 7020 updates the current initial weight using the most recently received weight of the remaining goods on the product tray 1001 after a purchase. The data storage 7026 also stores other essential data information that is required for the central processing unit 7020 to perform its tasks. The essential data information may be initialized via data initialization or received from the cloud-based server 7100.

The keypad 7041 may be installed on the control panel 1008 or on the back of the base unit 1009. Keypad operation signals are passed to the central processing unit 7020 via the keypad interface 7040.

When detecting abnormal activities, the central processing unit 7020 controls the alarm 7029 to generate alerts. The central processing unit 7020 may also be linked to a cloud-based server 7100 via the communication module 7024, hence enabling a remote control or off-site control of the self-checkout vending apparatus.

The sliding door controller 7030 may be integrated into the central processing unit 7020 as a function of the central processing unit. Alternatively, the controller 7030 is implemented separately. The controller 7030 is connected to the central processing unit 7020 and the motor driver 7032 which is connected to the motor 7033. A control signal from the central processing unit 7020 is processed by the sliding door controller 7030 and forwarded to the motor driver 7032, which then drives the motor 7033 to rotate, which then opens or closes the sliding door 1004 accordingly.

The end button 7031 (7031 in FIG. 7 or 1003 in FIG. 1) can be connected in two different methods. In the first method, the end button 7031 is connected to the sliding door controller 7030. When a customer finishes getting goods, the customer presses the end button 7031, hence sending a completion signal to the sliding door controller 7030. The sliding door controller 7030 signals the motor driver 7032 to close the sliding door 1004, and at the same time passes the completion signal to the central processing unit 7020. Upon receiving the completion signal, the central processing unit 7020 calculates the amount due and sends the amount due to the operation and accounting platform via the transceiver 7025.

In the second method, the end button 7031 is connected directly to the central processing unit 7020. When a customer finishes getting goods, the customer presses the end button 7031, hence sending a completion signal to the central processing unit 7020. Upon receiving the completion signal, the central processing unit 7020 calculates the amount due and sends the amount due to the operation and accounting platform via the transceiver 7025. At the same time, the central processing unit 7020 forwards the completion signal to the sliding door controller 7030. The sliding door controller 7030 signals the motor driver 7032 to close the sliding door 1004.

The present invention further comprises an operation and accounting platform 7021, which is wirelessly connected to the self-checkout vending apparatus. The self-checkout vending apparatus has a QR code or a QR code reader and can communicate with the operation and accounting platform 7021 via a scan of the QR code or the QR code reader. The operation and accounting platform 7021 comprises the accounting module 7022 and the operation identification module 7023. The operation identification module 7023 can communicate with user devices, such as mobile phones, and carry out user identification. The accounting module 7022 is responsible for communicating with the remote payment and accounting terminal (for example, WeChat and Alipay). The operation and accounting platform is wirelessly connected via the transceiver 7025. Preferably the transceiver 7025 is a wireless LAN transceiver and connects the central processing unit 7020 for external data communication.

When a customer using a mobile phone to scan the QR code or be scanned by the QR code reader, the operation identification module 7023 identifies the information scanned and sends confirmation information to the transceiver 7025. The transceiver passes the confirmation information to the central processing unit 7020, which in turn generates a control signal to open the sliding door 1004 to allow the customer to access the goods offered by the self-checkout vending apparatus. When the central processing unit 7020 generates a making payment signal and sends it to the remote accounting module 7022 via the transceiver 7025, the remote accounting module 7022 directly charges the payment amount to the customer account using a password-less authentication, or auto-debit service. Alternatively, the remote accounting module 7022 sends the payment information to the customer's mobile phone and allows the customer completes the transaction according to the payment information received. Finally, the remote accounting module 7022 sends the payment completion information to the central processing unit 7020 via the transceiver 7025. The payment completion information is to be stored in the data storage 7026.

In a further preferred embodiment, the self-checkout vending apparatus comprises a card reader embedded in the code scan area to support the conventional card payment means (for example, paying with debit/credit cards). Said card reader may be connected to the transceiver 7025. The automatic control of the sliding door 1004 may be based on signals from the car reader. And the payment transactions may be through the card reader.

An exemplary operating procedure of a self-checkout vending apparatus in accordance with the present invention is as follows.

A type of goods has been placed on the product tray of the self-checkout vending apparatus.

When a customer wants to buy the goods, he/she scans the QR code or uses the QR code reader on the self-checkout vending apparatus with a mobile phone.

The scanning activity triggers a request for access to goods is sent to the central processing unit. The central processing unit checks if the self-checkout vending apparatus is out of stock by measuring the current weight on the product tray. An out-of-stock alert will be triggered and transmitted by the central processing unit if the weight measured is zero. Otherwise, after a successful scan, the transceiver receives a scan confirmation information and provides an open access request information to the central processing unit. The central processing unit generates a signal to the sliding door controller based on the open access request information, and in turn open the sliding door via the electric motor. Therefore, it enables the customer to take the desired amount of goods.

When customers are taking goods from the product tray, the load cells continuously measure the current weight on the product tray and sends the real-time data to the central processing unit. The customers may press an end button when finishing getting the goods, which will notify the central processing unit to close the product access window and calculate the final weight of the goods sold by finding the difference between the weight on the scale before and after the transaction. The amount due is then computed by multiplying the weight of the goods sold and the unit price of the goods and then is displayed to customers. The central processing unit will generate payment information and send it to the remote accounting module, which then carries out a password-less authentication, or auto-debit service, or display the payment information at the customer's mobile phone to complete the payment transaction. Finally, the central processing unit retracts the sliding door and closes the product access window and completes the whole vending process.

The present invention comprises a self-checkout vending apparatus that enables purchasing and self-checkout of unpackaged products without assistance from checkout attendants. The invention utilizes the weighing by difference approach, where the weight of goods sold is the difference between the weight measurement of the product tray before and after product selling, and the weight is multiplied by the unit price of the goods to obtain the total cost of the sale. This effectively tackles the problem of lacking a payment and accounting method for unpackaged products in current vending machines and enables self-checkout vending apparatus for unpackaged products. The present invention further connects a cloud-based server to with user devices and allows monitoring and controlling of vending apparatuses remotely. By using a code scan area, the self-checkout vending apparatus can automatically open and close the product access window, as well as automatically perform the payment operation, which greatly simplifies the sales operations. The present invention has broad applications as it enables unmanned automated retail for any packaged or unpackaged products, such as fruits, meals, beverages, etc.

### C. Detailed Description of the Second Embodiment

As illustrated in FIGS. 3-7, a second embodiment of self-checkout vending apparatus is based on a weighing by difference method for selling any products. The apparatus comprises a display 2008 (i.e., 7051 in FIG. 7), a keypad 7041, an alarm 7029, a fixed cover 2001, a roll top cover 2002, a transmission gear 2003, a bearing 2004, a motor gear 2005, an electric motor 2006, a base unit 2007, a fitting component 2011, a product tray 2012, a control panel 2013, and a controller unit. As illustrated in FIG. 7, the controller unit further comprises load cells 7003, a central processing unit 7020, a power supply 7010, a keypad interface 7040, a display interface 7050, a roll top cover controller 7030 (optional), a motor driver 7032, a data storage 7026, a transceiver 7025, and a communication module 7024. The present invention may further comprise a cloud-based server 7100 that controls the self-checkout vending apparatus remotely.

The self-checkout vending apparatus is equipped with QR code or QR code reader for making payments. User scanning the QR code or QR code reader scanning a user app code generates a request for getting goods to the central processing unit 7020. A reset button 2010 is mounted on the base unit 2007 and connected to the central processing unit. Pressing the reset button 2010 after collecting the desired amount will trigger a completion signal to the central processing unit 7020.

The central processing unit 7020 first determines if the vending apparatus is in stock after receiving the request. Specifically, the central processing unit 7020 reads the measurement by the load cell 7003 and checks if the detected weight on the product tray 2012 is zero. If it is, the vending apparatus is determined to be out of stock and the central processing unit displays an out-of-stock message; otherwise, the central processing unit drives an actuator to roll up the top cover.

As illustrated in FIGS. 3-7, the control panel 2013 is on top of the base unit 2007. In a preferred embodiment, the control panel 2013 is made of fine-quality glass. The base unit 2007 has a rectangular opening on the top, where the product tray 2012 is placed. The product tray 2012 is used for placing a given amount of goods, which are a type of product, especially unpackaged product, that is offered for sale. One or more load cells 7003 are under the product tray 2012. The load cells 7003 are connected to a central processing unit 7020. The load cells 7003 measure the current weight of the remaining goods on the product tray 2012 and updates the central processor 7020 about the weight in real time. When the central processor 7020 receives a completion signal, the central processor 7020 calculates an amount of goods taken by a customer (i.e., weight of goods sold) based on the difference between an initial goods weight from the load cells 7003 and the current remaining goods weight from the load cells 7003. The completion signal indicates that the customer has finished taking the goods from the product tray 2012. Next, the central processor 7020 calculates a cost of the goods taken by the customer (i.e., payment amount) based on the weight of goods sold and a unit price of goods (i.e., the unit price for the type of product for sale). The unit price is stored in a data storage 7026. The unit price is initialized when the self-checkout vending apparatus is furnished with the goods for sale. The data storage 7026 also stores the initial goods weight before the customer takes goods. The initial goods weight is updated by the current remaining goods weight each time after a sales transaction from the self-checkout vending apparatus is ended.

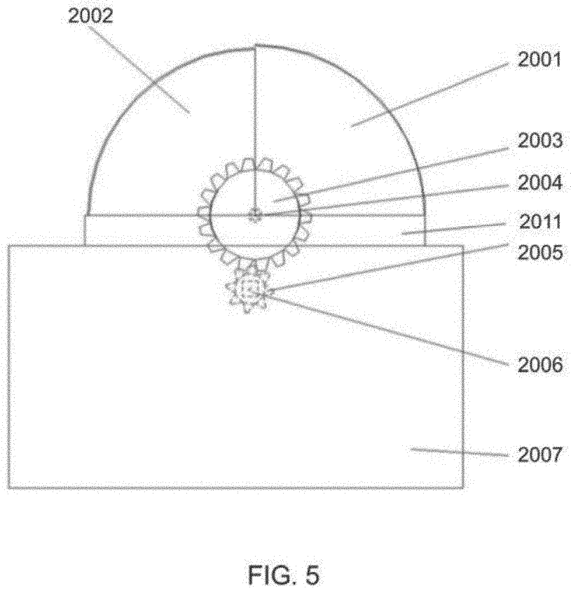

The product tray 2012 is surrounded by a fitting component 2011. The fitting component is securely mounted on the base unit 2007 and forms a rectangular surrounding structure outside of the product tray 2012. The fixed cover 2001 is fastened onto the base unit 2007 by attaching it to the inner surface of the fitting component 2011. The fixed cover 2001 is preferably made of transparent curved glass, allowing customers to clearly see the goods on the product tray 2012. The fixed cover 2001 has a front, a back, and two ends. As shown in FIG. 5, the ends of the fixed cover 2001 are roughly a quarter circle shaped. The fixed cover 2001 is in the shape of a quarter cylinder. The bottom part of the fixed cover 2001 may be fastened onto the fitting component 2011 using glue, recessed grooves, screws, or other methods. The roll top cover 2002 has a shape that is consistent with the fixed cover 2001. The roll top cover 2002 also has a front, a back, and two ends, and is of the same shape as the fixed cover 2001. The diameter of the roll top cover is slightly smaller than that of the fixed cover 2001. The side of the roll top cover has a slightly smaller O.D (i.e., outside diameter) than the I.D. (inner diameter) of the side of the fixed cover 2001 and it is also shorter. Both sides are of same thickness. The roll top cover 2002 can be rolled up and be completely housed inside of the fixed cover 2001. The opening of the fixed cover 2001 faces to the control panel 2013. The fixed cover 2001 together with the roll top cover 2002 when closed fully encloses the product tray 2012 and the goods on it. When the roll top cover 2002 is rolled up, it opens a product access window for customers to get the goods on the product tray 2012.

The fitting component 2011 may have a groove surrounding the bottom of the inner surface that match the edges of the roll top cover. In this way, the roll top cover when closed is sitting on the fitting component 2011. To open and close the product access window, the self-checkout vending unit may further comprise an actuator to control the roll top cover 2002. The actuator is connected to the roll top cover 2002 and can drive the top cover 2002 to rotate along the inner surface of the fixed cover 2001 until it is fully housed or fully returned. When the roll top cover 2002 is completely housed by the fixed cover 2001, the product access window is opened. When the roll top cover is returned to its initial position, the product access window is closed. As illustrated in FIG. 3, the actuator comprises a transmission gear 2003, a bearing 2004, a motor gear 2005, an electric motor 2006 and its driver. The transmission gear 2003 is attached to the inner surface of one end of the roll top cover. The transmission gear 2003 is fastened on one end of the roll top cover 2002. In an alternative implementation, both ends of the roll top cover may be equipped with synchronized transmission gears, depending on the strength of actuation. The center of the transmission gear 2003 is attached to the fitting component 2011 via the bearing 2004. The bearing 2004, supporting the rotation of the transmission gear 2003 and the roll top cover 2002, comprises 2 ball bearings that are set up collinearly. The ball bearings are attached to the two sides of the fitting component 2011 through the holes located near the corner of the roll top cover 2002. The bearing 2004 is mounted to the transmission gear 2003 that is fastened on the inner surface of one end of the roll top cover 2002. The roll top cover 2002 may be partially overlapped by the fixed cover 2001. On the fixed cover 2001 and the roll top cover 2002, the holes through which the ball bearings are mounted to both ends of the fitting component 2011 are also in the same position. This allows the transmission gear 2003 to rotate freely around the fixed axis of the bearing 2004. The rotation of the transmission gear 2003 may then engage the rotation of the attached roll top cover 2002. The transmission gear 2003 is engaged with the motor gear 2005, which is positioned within the base unit 2007. The center of the transmission gear 2005 is connected to the output shaft of the motor 2006. The motor 2006 is mounted within the base unit 2007 and is connected to the motor driver. When the motor driver 7032 is instructed by the central processing unit 7020 to open the product access window, the motor 2006 turns on and the movement of its output shaft engages the rotation of the motor gear 2003, which engages the rotation of the transmission gear 2003 and the top cover attached to it. The top cover 2002 is being rolled towards the fixed cover 2001 until being fully housed. This opens the product access window and allows a customer to take a desired amount of goods. When the customer finishes, the central processing unit 7020 signals the motor driver 7032 to close the product access window. The motor drive 7032 re-starts the motor 2006, whose output shaft drives the motor gear 2005 to rotate reversely, engaging the rotation of the transmission gear 2003 and the top cover 2002 that is attached to it. The top cover 2002 is being retracted away from the fixed cover 2001 until it fully covers the product tray 2012 together with the fixed cover 2001. The movements of the transmission gear 2003, the motor gear 2005, the motor 2006 and the bearing 2004 do not interfere the product tray 2012.

The control panel 2013 further comprises a display 2008, a code scan area 2009, and a reset button 2010, which are preferably in the front of the roll top cover 2002. The display 2008 (i.e., 7051 in FIG. 7) is connected to the central processing unit 7020 via the display interface 7050. The central processing unit 7020 displays customer's purchasing and payment information on the display 2008 in real time. The code scan area 2009 has a QR code that supports payments via WeChat and payments via Alipay. Alternatively, the code scan area 2009 may have a code reader that supports WeChat payment and Alipay. The reset button 2010 is connected to either the central processing unit 7020 or the roll top cover controller 7030. The fixed cover 2001 and the roll top cover 2002 are preferably made of fine-quality transparent glass. The control panel 2013 is preferably made of fine-quality glass.

A controller unit is inside the base unit 2007. The controller unit comprises load cells 7003, a central processing unit 7020, a power supply 7010, a keypad interface 7040, a display interface 7050, a motor driver 7032, a data storage 7026, a transceiver 7025, and a communication module 7024. The central processing unit 7020 is preferably an ARM 32-bit central processor. The central processing unit 7020 is connected to the load cells 7003, the power supply 7010, the keypad interface 7040, the display interface 7050, the alarm 7029, the data storage 7026, the transceiver 7025, and the commination module 7024.

The load cells 7003 detect a current weight of remaining goods on the product tray 2012 and sends a measurement to the central processing unit 7020 in real time. Hence the central processing unit 7020 has an initial weight of the goods on the product tray 2012 before a customer starts taking some goods from the vending apparatus. After the customer finishes taking the desired amount of goods from the vending apparatus, the central processing unit 7020 receives a completion signal and then automatically calculates and displays a cost of goods taken by the customer based on the following: the most updated weight of remaining goods on the product tray 2012, a weight difference between the initial weight stored in the data storage and the most updated weight, and the unit price of the goods stored in the data storage. The central processing unit 7020 generates an amount due based on the cost of goods taken by the customer. Finally, the central processing unit 7020 shows the amount due on the display 2008 to the customer and sends the amount due to an operation and accounting platform 7021 to close the transaction.

The data storage 7026 connected to the central processing unit 7020 stores the unit price of the goods offered for sale and the initial weights of the goods prior to each transaction. The unit price is received during an initialization when the vending apparatus is replenished with the goods for sale. The initial weights are obtained from the weights of the remaining goods on the product tray 2008 after each transaction. The central processing unit 7020 updates the current initial weight using the current weight of the remaining goods on the product tray 2008 after each time generating the amount due for payment. The data storage 7026 also stores other essential data information that is required for the central processing unit 7020 to perform its tasks. The essential data information may be initialized via data initialization or received from the cloud-based server 7100.

When detecting anomalies, the central processing unit 7020 controls the alarm 7029 to produce alerts. The central processing unit 7020 may be linked to a cloud-based server 7100 via the communication module 7024 for remote operation and monitoring of the vending unit. The information stored in the data storage 7026 may also be entered via the cloud-based server 7100.

The keypad 7041 is mounted on the back panel of the base unit and sends corresponding keypad operation information to the central processing unit 7020.

The roll top cover controller 7030 may be integrated into the central processing unit 7020 (that is, the controlling functions are added to the central processing unit). Alternatively, the controller 7030 is implemented separately. The controller 7030 is connected to the central processing unit 7020 and the motor driver 7032 which is connected to the motor 7033. A control signal from the central processing unit 7020 is processed by the top cover controller 7030 and forwarded to the motor driver 7032, which then drives the motor 7033 to rotate.

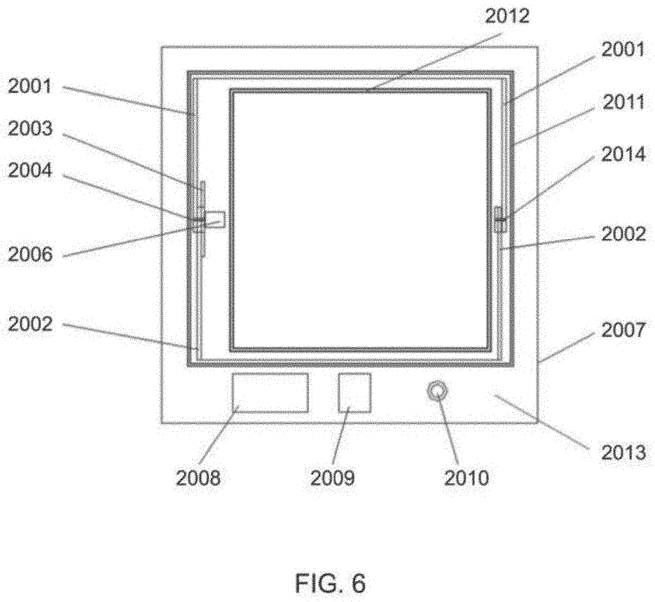

The reset button 7031 (7031 in FIG. 7 or 2010 in FIGS. 3 and 6) can be connected in two different methods. In the first method, the reset button 7031 is connected to the roll top cover controller 7030. When a customer finishes getting goods, the customer presses the reset button 7031, hence sending a completion signal to the roll top cover controller 7030. The roll top cover controller 7030 signals the motor driver 7032 to close the roll top cover 2002, and at the same time passes the completion signal to the central processing unit 7020. Upon receiving the completion signal, the central processing unit 7020 calculates the amount due and sends the amount due to the operation and accounting platform via the transceiver 7025 to settle the payment transaction.

In the second method, the reset button 7031 is connected directly to the central processing unit 7020. When a customer finishes getting goods, the customer presses the reset button 7031, hence sending a completion signal to the central processing unit 7020. Upon receiving the completion signal, the central processing unit 7020 calculates the amount due and sends the amount due to the operation and accounting platform via the transceiver 7025. At the same time, the central processing unit 7020 forwards the completion signal to the roll top cover controller 7030. The roll top cover controller 7030 signals the motor driver 7032 to close the roll top cover 2002.

The present invention further comprises an operation and accounting platform 7021, which is wirelessly connected to the self-checkout vending apparatus. The self-checkout vending apparatus may be equipped with a QR code or a QR code reader and can communicate with the operation and accounting platform 7021 via the scan of the QR code or the QR code reader. The operation and accounting platform 7021 comprises the accounting module 7022 and the operation identification module 7023. The operation identification module 7023 can communicate with a consumer device, such as a mobile phone, and carry out consumer identification. The accounting module 7022 may be a remote payment terminal, such as a WeChat or Alipay service terminal. The operation and accounting platform is wirelessly connected via the transceiver 7025. Preferably the transceiver 7025 is a wireless LAN transceiver and connects the central processing unit 7020 for external data communication.

When the QR code or the QR code reader is scanned by the consumer, the operation and accounting platform 7021 confirms the consumer's identification and sends confirmation information to the transceiver 7025, which then requests for opening the product access window to the central processing unit 7020. The central processing unit 7020 then drives the roll top cover controller 7030 to roll the cover and open the product access window, which allows the consumer to get the goods on the product tray. The accounting signal generated by the central processing unit 7020 is sent to the remote accounting module 7022, which settles the payment via password-less authentication or displays the payment information to the customer's mobile phone and allows the customer to complete the transaction according to the payment information received. The settled payment information is then fed to the transceiver 7025, which sends the information to the central processing unit 7020. The central processing unit 7020 then stores the payment information.

In a further preferred embodiment, the self-checkout vending apparatus comprises a card reader on the control panel 2013 to support the conventional card payment means (i.e., paying with debit/credit cards). The card reader may be connected to the transceiver 7025. The automatic control of the roll top cover 2002 may be based on signals from the car reader.

A brief exemplary operating procedure of a self-checkout vending apparatus in accordance with the second embodiment of the present invention is as follows.

First, goods to be sold are placed on the product tray of the self-checkout vending apparatus.

A customer may scan the QR code or use the QR code reader on the self-checkout vending apparatus. The scanning activity is confirmed by the operation identification module. The confirmation information is received by the transceiver, which then passes the request for opening the product access window to the central processing unit. The central processing unit then drives the roll top cover controller to rotate the motor and open the roll top cover to open the product access window. While the customer is getting goods, the load cell measures the current weight of goods on the product tray and sends its measurement to the central processing unit. The customer may press the reset button when finishing getting goods, which triggers the signal that closes the product access window. The motor then rotates reversely, engaging a reverse rotation of the gear that retracts the roll top cover to close the product access window. Meanwhile, the reset button sends a completion signal to the central processing unit. The central processing unit calculates the weight of goods sold based on the difference between the weight on the product tray before the customer gets the goods and the weight on the product tray after the customer gets the goods. The central processing unit calculates the amount due by multiplying the weight of goods sold by the unit price of the goods. The payment information is then transmitted to the remote accounting terminal, which then settles the payment via password-less authentication accordingly. The remote accounting terminal then stores the payment information in the storage system, signaling the completion of this self-checkout.

The present invention is a self-checkout vending apparatus that supports vending of any unpackaged products, such as fruits and meals, and has broad market applications. The invention introduces a weighing by difference technique to measure the weight of goods sold by finding the difference between the weight on the product tray before and after a user gets the desired amount of goods. The total amount due is determined as the product of the weight of goods sold and the unit price of the goods. This solves the limitation of current vending machine implementations that support only packaged products with pre-determined prices. The present invention improves the vending machine technologies. In addition, the present invention connects a cloud-based server and consumer devices in operation, allowing an automatic opening/closing of a product access window and enabling password-less authentication via QR code, which considerably simplifies the customer operations. The present invention has broad market applications and can be applied to self-checkout of any type of unpackaged products, such as fruits, meals, ice creams, beverages, etc.

### D. Detailed Description of the Third Embodiment

As illustrated in FIGS. 8 and 9, the present invention comprises a self-checkout vending apparatus which is based on a weighing by difference method and enables vending unpackaged products like cooked food, fruits, and vegetables. The vending apparatus may have a freezer, a refrigerator, or a fresh-keeping cabinet. The vending apparatus comprising a display unit 3001, product trays 3002, load cells 3003, shelves 3004, a cabinet body 3005, an electromagnetic lock 3006, a cabinet door 3007, a rack 3008, and a controller unit. The controller unit comprises a door lock sensor 9028, a central processing unit 9020, an electromagnetic lock driver 9027, a data storage 9026, a transceiver 9025, an alarm 9029, and a communication module 9024.

In FIG. 8, the cabinet 3005 has a multiple-tier shelving structure. As shown, a rack has four vertical parallel bars mounted at the cabinet inner corners. Each bar has a plurality of evenly spaced holes. The shelves 3004 comprises left beams, middle beams, and right beams. Each beam can be connected to the different positions on the rack using different holes. Each one of the middle beams of the shelves 3004 is equipped with the load cells 3003. Each product tray 3002 is placed on one of the shelves 3004 above the load cells 3003. The load cells 3003 detect a weight on each product tray 3002 in real time. The controller box is located on top of the cabinet 3005. The controller box contains the display unit 3001 and the controller unit. The display unit 3001 includes a monitor. The electromagnetic lock 3006 may be equipped between the cabinet frame and the cabinet door. The controller unit may be equipped in the controller box. The electromagnetic lock 3006, the load cells 3003, the display unit 3001 are connected to the controller unit. If the vending apparatus has a temperature control, a cooling unit that keeps the products fresh may be located at the bottom of the cabinet.

As illustrated in FIG. 9, the controller unit comprises the door lock sensor 9028, the central processing unit 9020, the electromagnetic lock driver 9027, the data storage 9026, the transceiver 9025, the alarm 9029, and the communication module 9024. The present invention may also include a cloud-based server that can remotely control the vending apparatus. The central processing unit 7020 is preferably the ARM 32-bit microcontroller. The load cells 3003 are connected to the central processing unit 7020 and update the central processing unit 7020 regarding the weight on each product tray in real time. Based on that, central processing unit 7020 determines a weight of goods sold based on the difference of the detected weights before and after a sale. The door lock sensor 9028 detects whether the door is closed and sends its detected door status to the central processing unit 7020.

The data storage 9026 is connected to the central processing unit 9020 and stores unit price information, initial weight information, and other information of the products for sale. More specifically, the unit price information and initial weight information of goods on each product tray are stored in the system, where the information can be indexed according to the IDs of the load cells beneath product trays. An exemplary format of the information records is illustrated in table 1 below:

TABLE 1

| | | | |
|---|---|---|---|
| Load cell ID1 of | Unit Price of goods | Initial weight of goods | . . . |
| product tray 1 | on product tray 1 | on product tray 1 | |
| Load cell ID2 of | Unit Price of goods | Initial weight of goods | . . . |
| product tray 2 | on product tray 2 | on product tray 2 | |
| Load cell ID3 of | Unit Price of goods | Initial weight of goods | . . . |
| product tray 3 | on product tray 3 | on product tray 3 | |
| . . . | . . . | . . . | . . . |

The IDs for load cells, the unit price information, and initial weight information for goods on each product tray are initialized via a remote server or the keypad after each replenishment. The initial weight information is updated by the central processing unit 9020 each time a purchase is completed. The above information records may also include the name of goods on each product tray as illustrated in table 2 below:

TABLE 2

| | | | | |
|---|---|---|---|---|
| Load cell ID1 | Unit Price of | Name of goods | Initial weight | . . . |
| of product | goods on product | on product | of goods on | |
| tray 1 | tray 1 | tray 1 | product tray 1 | |
| Load cell ID2 | Unit Price of | Name of goods | Initial weight | . . . |
| of product | goods on product | on product | of goods on | |
| tray 2 | tray 2 | tray 2 | product tray 2 | |
| Load cell ID3 | Unit Price of | Name of goods | Initial weight | . . . |
| of product | goods on product | on product | of goods on | |
| tray 3 | tray 3 | tray 3 | product tray 3 | |
| . . . | . . . | . . . | . . . | . . . |

The data storage 9026 stores the identification, unit price and initial weight information for products (i.e., goods) on each product tray. The identification for each product is used as indices to the corresponding unit price and initial weight information. The identification and unit price information are entered when initializing the system, and the initial weight is updated as the most recently detected weight on the tray by the load cells.

The door lock sensor 9028 is connected to the central processing unit 9020 and sends real-time detection of door status change to the central processing unit 9020. Having detected that the door is closed, the central processing unit 9020 performs the following operations:

(1) Reading the current remaining weight of goods on a product tray.

(2) Reading the unit price and the initial weight of the goods in the product tray according to their identifications.

(3) Subtracting the current remaining weight obtained in step (1) from the initial weight obtained in step (2) to get the weight of goods taken.

(4) Multiplying the weight of goods taken, which is obtained in step (3), by the unit price obtained in step (2) to get the amount due.

(5) Updating the initial weight in the data storage using the most recently detected weight on the tray, which is obtained in step (1).

(6) Repeating steps (1)-(5) until the amount due for each product tray is determined and the initial weight information for each product tray is updated.

(7) Summing all obtained amounts in step (6) to get the total amount due for this purchase. Displaying the amount due information to customers and controlling the electromagnetic lock driver to lock the cabinet door once it is closed. The payment information will be transmitted by the transceiver 9025 to the cloud-based operation and accounting platform, allowing it to complete the payment process via password-less authentication.

The display unit 3001 is connected to the central processing unit 9020 and may be used to indicate or display the payment information, the unit price, the operation instruction, the connection status, or commercials. The display unit 3001 may also display a QR code to be scanned. The alarm 9029 is connected to the central processing unit and may be used to generate alerts when being instructed by the central processing unit. The electromagnetic lock driver 9027 is connected to the central processing unit and may be used to lock or unlock the electromagnetic lock 3006 according to the instructions from the central processing unit. The transceiver 9025 is connected to the central processing unit and may be used to transmit external signals, like the QR code signal or the completion-of-payment signal, from the operation and accounting platform 9021 to the central processing unit 9020. It may also transmit the payment information from the central processing unit 9021 to the operation and accounting platform 9021. The central processing unit 9020 is connected to a remote cloud-based server 9100, which monitors the operation of the vending apparatus remotely and updates the unit price and product name in the data storage 9026.

The present invention comprises the operation and accounting platform 9021, which is connected to the self-checkout vending apparatus wirelessly. The display unit 3001 may be equipped with a QR code or a QR code reader, enabling the communication with the operation and accounting platform 9021. The operation and accounting platform 9021 is a cloud-based service platform, such as WeChat or Alipay, that comprises the accounting module 9022 and the operation identification module 9023. The operation identification module 9023 is used to confirm the identification of customers by their operation terminals like mobile devices. The operation and accounting module 9023 is wirelessly connected to the transceiver 9025. The wireless transceiver 9025 connects the central processing unit 9020 to the external platforms. When customers scan the QR code or use the QR code reader with their mobile devices, the operation identification module 9023 confirms the customers' identification to the transceiver, which then transmits the confirmation information to the central processing unit 9020. The central processing unit then drives the electromagnetic lock driver 9027 to unlock the door 3008 so that customers can get the goods that are in stock in the vending apparatus. The payment information generated by the central processing unit 9020 is transmitted to the accounting module 9022 by the transceiver 9025. The accounting module 9022 then settles the payment via password-less authentication or displays the payment information to customers, allowing them to pay online. When the payment is received, the accounting module 9022 sends the confirmation and transaction details to the transceiver 9025, which forwards the information to the central processing unit 9020. The central processing unit 9020 stores the transaction details in the data storage 9026. Further, the self-checkout vending apparatus may be equipped with a card reader to support the traditional payment via debit or credit cards. The card reader, if included, is connected to the transceiver 9025 so that the payment can be via the card reader and the locking or unlocking of the cabinet door 3007 is dependent on the status of the card reader.

An exemplary operation of the present invention will be explained as follows. Each product tray holds goods (for example, fruits or vegetables) with same unit price. The load cell IDs, the unit price information, the names of the goods (optional) and the initial weights are entered into the system after replenishment. A customer may scan the QR code using his/her mobile device or use the QR code reader to scan his/her payment app code. The operation identification module 9023 of WeChat or Alipay then confirms the customer' ID and sends a confirmation to the transceiver, when transmits the confirmation to the central processing unit 9020. Upon receiving the confirmation, the central processing unit 9020 first determines if goods in the vending apparatus is out of stock by reading the weight measurement from each product tray and check if they are all zeros. If they are, the central processing unit 9020 triggers an alarm and show an out-of-stock alert on the display unit 3001. Otherwise, the central processing unit 9020 drives the electromagnetic lock driver 9027 to unlock the cabinet door 3007 so that customers may get the goods they want. The load cells sense the real-time weight data change during the customer operation and update the measurements to the central processing unit 9020. When finished, the customer may close the door manually. To remind that customer of closing the door after taking the desired goods, a voice reminder will be announced by the alarm during the customer operation. After closing the door, the door lock sensor updates the action to the central processing unit, which then performs the following operations:

(a) Reading the current remaining weight on a product tray.

(b) Reading the unit price and initial weight information of the goods according to the product tray's corresponding load cells ID.

(c) Subtracting the current remaining weight obtained in step (a) from the initial weight obtained in step (b) to get the weight of goods sold.

(d) Multiplying the weight of goods sold, which is obtained in step c), by the unit price obtained in step (b) to get the amount due.

(e) Updating the initial weight in the data storage using the most recently detected weight on the product tray, which is obtained in step (a).

(f) Repeating steps (a)-(e) until the amount due for each product tray is determined and the initial weight information for each product tray is updated in the data storage.

(g) Summing all the obtained amount dues in step (f) to get the total amount due for this purchase. Displaying the amount due information to customers and controlling the electromagnetic lock driver to lock the cabinet door once it is closed. The payment information will be transmitted by the transceiver to the cloud-based operation module, allowing it to settle the payment via password-less authentication. The details are then sent by the accounting and operation module to the central processing unit, which stores the details in the data storage. The accounting and operation module will display the details to customers in their WeChat account. Customers may also track their expense details and history by following the retail company's official WeChat account, wherein the retail company operates the vending apparatus.

The present invention is a self-checkout vending apparatus that enables purchasing any type of products, packaged or unpackaged, without assistance from a checkout attendant. The present invention introduces a weighing by difference approach, wherein the weight of goods sold is the difference between the weights on a weighing scale before and after a customer taking a desired amount of goods, and this weight of goods sold is multiplied by the unit price of the goods to obtain the total cost of the purchase. This effectively addresses the lack of payment and accounting method for unpackaged products in current vending machines and improves the self-checkout vending technology. This present invention further connects a cloud-based server to user devices, allowing monitor and control of the vending apparatuses remotely. By equipping a vending apparatus with a code scan area, the opening/closing of the product access window as well as the payment can be performed automatically, which largely simplifies the customer operation. The present invention has broad applications and can used in automated retail solutions for any type of unpackaged products, such as fruits, meals, ice creams, beverages, etc.

### D. Conclusion

While various embodiments of the present invention have been described above, it should be understood that they have been presented by way of examples, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A weight-based vending apparatus comprising a data storage, a display, and a product tray,
wherein the product tray holds goods offered for sale; the data storage stores a unit price of the goods and an initial weight of the goods on the product tray;
upon receiving a confirmation of a user's identification, the weight-based vending apparatus performs following steps:
measuring a current weight of the goods on the product tray in real time;
calculating a weight of goods taken by the user based on the difference between the initial weight and the current weight;
calculating a cost of goods taken by the user based on the weight of goods taken by the user and the unit price;
upon receiving a completion signal, calculating an amount due based on the cost of goods taken by the user, showing the amount due on the display, and sending the amount due to an external entity for processing a payment.

2. The apparatus of claim 1 further comprising a controlled access to the goods offered on the product tray; upon receiving the confirmation of the user's identification, the weight-based vending apparatus automatically operates the controlled access so that the user can access to the goods offered on the product tray.

3. The apparatus of claim 2, wherein the controlled access comprises a sliding door controlled by the weight-based vending apparatus.

4. The apparatus of claim 2, wherein the controlled access comprises a roll top cover controlled by the weight-based vending apparatus.

5. The apparatus of claim 2, wherein the controlled access comprises a lock controlled by the weight-based vending apparatus.

6. The apparatus of claim 2, wherein upon receiving the completion signal, the weight-based vending apparatus automatically operates the controlled access to end the user access to the goods offered on the product tray.

7. The apparatus of claim 1, wherein the confirmation of the user's identification is triggered by the user when the user performs a scan activity with the weight-based vending apparatus.

8. The apparatus of claim 7 further comprising a QR code, and the scan activity comprises the user scans the QR code with a mobile device.

9. The apparatus of claim 7 further comprising a card reader, and the scan activity is detected by the card reader.

10. The apparatus of claim 1, wherein the unit price of the goods is entered when the product tray is replenished.

11. The apparatus of claim 1, wherein the initial weight of the goods on the product tray stored in the data storage is updated after a purchase is made.

12. The apparatus of claim 1 further comprising a button, and the completion signal is generated by the user pressing the button.

13. The apparatus of claim 1 further comprising a door, and the completion signal is generated by the user closing the door.

14. The apparatus of claim 1 generates alerts when detecting abnormal activities.

15. The apparatus of claim 1 checks if the product tray is empty and generates an out-of-stock alert if the product tray is empty.

16. The apparatus of claim 1 further comprising one or more product trays and load cells that are integrated with the weight-based vending apparatus; wherein for each product tray, there are load cells under said each product tray, and the weight-based vending apparatus monitors weight of goods on said each product tray.

17. The apparatus of claim 16, wherein the weight-based vending apparatus may offer different products on different product trays; the unit prices for different products are stored in the data storage and indexed according to identification for each product.

18. The apparatus of claim 1 communicates with a cloud-based server.

19. The apparatus of claim 1, wherein the external entity for processing the payment comprises a WeChat or Alipay remote payment and accounting terminal.

20. A method for self-checkout using a weight-based vending apparatus, wherein the weight-based vending apparatus comprises a data storage, a display unit, and a product tray, the method comprising:
placing goods for sale on the product tray;
storing a unit price for the goods and an initial weight of the goods in the data storage;
Upon receiving a confirmation of the user's identification, the weight-based vending apparatus automatically performs the following steps:
measuring a current weight of the remaining goods on the product tray in real time;
calculating a weight of goods taken by the user based on the difference between the initial weight and the current weight;
calculating a cost of goods taken by the user based on the weight of goods taken by the user and the unit price;
detecting a completion signal;
calculating an amount due based on the cost of goods taken by the user and displaying the amount due on the display unit; and
sending the amount due to an external entity for processing a payment.
